(19) United States
(12) Patent Application Publication
(10) Pub. No.: US 2004/0190591 A1
(43) Pub. Date: Sep. 30, 2004

(54) Irreversible indication of overheated railway vehicle components

(76) Inventor: Ming Zhang, Montreal (CA)

Correspondence Address: Ming (Jason) Zhang, 5270 Rosedale Avenue, Montreal, QC, H4V 2H6, CA

(21) Appl. No.: 10/766,543

(22) Filed: Jan. 29, 2004

Related U.S. Application Data
(60) Provisional application No. 60/448,790, filed on Feb. 20, 2003.

(51) Int. Cl. G01K 1/02; G01K 1/08

(52) U.S. Cl. 374/162; 116/219; 374/153

(57) ABSTRACT

The present invention provides methods for precise and economical indication of overheated component of railway wheel set assembly.

The methods comprise:

(1) embedding a highly thermal conductive element to help monitor directly internal condition of a possible overheated axle/bearing assembly within the railway wheel set assembly.

The highly thermal conductive element, preferably with incorporated heat pipe means, may be in form of

A. a cap screw mounted to end of the axle or;

B. a cartridge like label carrier embedded in a hole inside bearing adapter;

(2) attaching, encapsulating and sealing permanently a non-reversible temperature indicating label, preferably a multiple-temperature type, at outside visible end of the highly thermal conductive elements that is readily accessible for quick inspection;

(3) embedding additional highly thermal conductive element and additional non-reversible temperature indicating labels in the wheel hub or brake disc, preferably with incorporated heat pipe means, to help determine positively if wheel or brake disc is overheated or the axle/bearing assembly is overheated.

### 1. CROSS REFERENCE TO RELATED APPLICATIONS

This application claims the benefit of U.S. Provisional Application No. 60/448,790 filed on Feb. 20, 2003, which is hereby incorporated by reference in its entirety.

### 2. TECHNICAL FIELD

The present invention relates generally to heat indication methods and apparatus to help monitoring temperature of critical vehicle or machinery components and preventing catastrophic failure related to overheated components. In particular, the present invention relates to method and apparatus for applying irreversible temperature indicators to components of wheel set assemblies of railroad vehicles.

### 3. BACKGROUND OF THE INVENTION

Overheated railway bearings and overheated railway wheels have led to catastrophic failures and train derailments costing the North American railroads millions of dollars each year.

Among various methods proposed for timely detection of troubled bearings or wheels in order to replace them, wayside hot bearing and hot wheel detection systems using infrared sensors are representative of the state of the art and presently applied in high traffic areas.

One of the major operational issue of using wayside detection system is that once a failing bearing or wheel triggers alarm, it is very difficult for locomotive engineer to perform physical verification on the overheated component. He has to stop the train, count number of axles, walk to the bearing or the wheel and then verify physically status of the bearing or wheel that triggered the alarm By the time the locomotive engineer finally locates the bearing or the wheel, some already cool down to normal temperature range. Without any positive proof of what had happened to the bearing or wheel, the locomotive engineer, in many cases, has to search more components and then report a false alarm. He then has to restart train hoping that the next wayside detectors will catch the troubled components in time if the bearing or wheel becomes hot again. In many cases, the overheated bearing or wheel actually fails quickly and catastrophic derailment occurs before the train reaches the next detector.

Another critical issue is the need for an economical backup system in case of failures of wayside detection system.

Several thermal indication devices in irreversible nature were promoted in the railway industry without much success due to either high cost of implementation or low reliability, such as

(1) Stink bomb or smoke bomb;

(2) Smart bolt equipped with wax motor and radio device;

(3) Visual indicators with spring means activated by fusible material.

The deficiencies associated with those thermal indicators are

1. Low reliability associated with fatigue or other mechanical failure of those indication devices under high impacts and constant vibration.

2. High implementation costs versus their limited use with the presence of wayside detectors.

3. Single-point alarm triggering provides only final last minute warning, allowing no possible preventative actions to be taken in advance.

Accordingly, what is needed in the art is a low cost yet reliable method and apparatus to provide precise and irreversible record of true temperature changes ever occurred to the specific component of wheel set assembly.

### 4. SUMMARY OF THE INVENTION

One object of the present invention is to provide method and apparatus for low cost, reliable and irreversible recording of temperature changes inside axle, journal bearing and wheel, as well as other critical vehicle/machine components, enabling train crew or field inspectors to identify positively overheated components even when the vehicle or machine stops running and/or before the wayside detectors trigger the final last minute alarms and/or in case of failure of wayside detectors.

Another object of the present invention is to provide low cost sealing/insulation/protection means for temperature recording media or apparatus against harsh working conditions, assuring long term durability and precise temperature recordings for whole service life of railway wheel set.

Other objects and advantages of the present invention can become more apparent to those skilled in the art as the nature of the invention is better understood from the accompanying drawings and a detailed description.

### 5. BRIEF DESCRIPTION OF THE DRAWINGS

FIG. 1 is a sectional cut away view of one embodiment of the present invention in which a bearing overheat indication assembly is mounted to head of cap screw and a wheel overheat indication assembly is applied to end of wheel hub.

FIG. 1A is an end view of cap screw and bearing overheat indication assembly.

FIG. 1B is a cross sectional view of the apparatus depicted in FIG. 1A.

FIG. 1C is a cross sectional view of alternative arrangement of the apparatus depicted in FIG. 1B.

FIG. 2 is a sectional cut away view of an alternate embodiment of the present invention.

FIG. 2A is an end view of the apparatus depicted in FIG. 2 taken along line 2A-2A.

FIG. 2B is an enlarged view of the apparatus around wheel hub depicted in FIG. 2.

FIG. 3 is an end view of an alternate embodiment of the present invention in which an alternative bearing overheat indication assembly is mounted in a bearing adapter.

FIG. 3A is a cross sectional view of the apparatus depicted in FIG. 3 taken along line 3A-3A.

FIG. 3B is a cross sectional view of an alternative arrangement of the apparatus depicted in FIG. 3.

FIG. 3C is a cross sectional view of another alternative arrangement of the apparatus depicted in FIG. 3.

### 6. DETAILED DESCRIPTION OF THE DRAWINGS

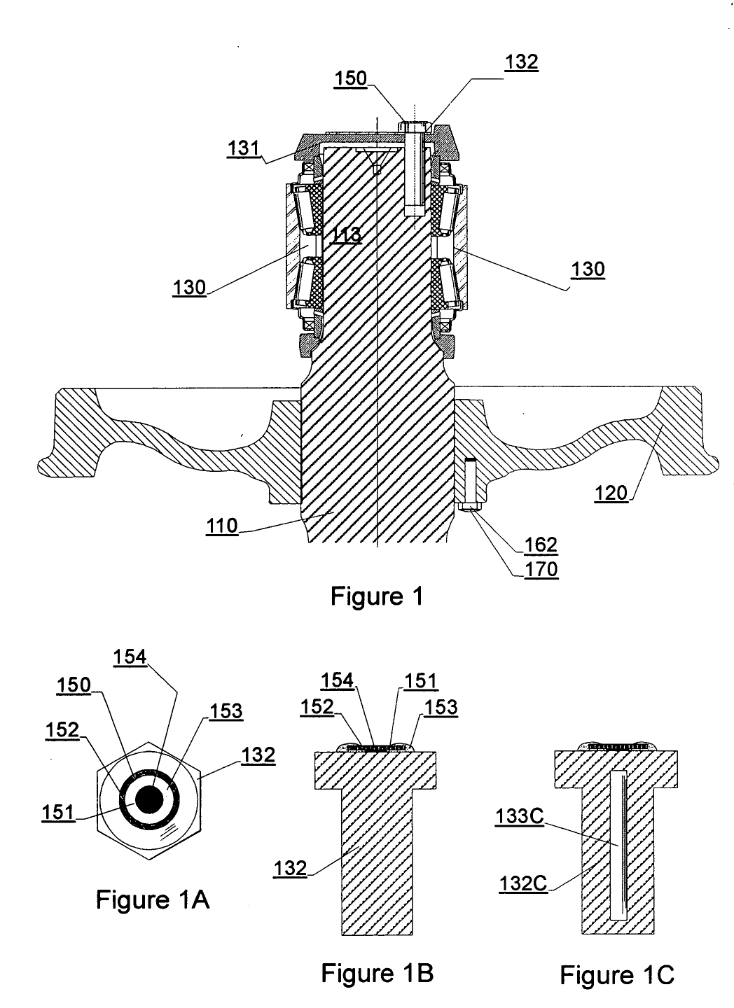

Referring to FIG. 1, half of a vehicle wheel set assembly is provided including a solid axle 110, a curved plate wheel 120, and an outboard tapered roller bearing assembly 130.

The wheel 120 is mounted and secured on the axle 110 with interference fit. The bearing assembly 130 is mounted with interference fit and retained by an end cap 131 with the help of a plurality of cap screws 132 bolted to the end of the axle 110.

The section of the said axle 110 under the bearing assembly 130 is referred as axle journal and indicated by number 113.

Each bearing assembly 130 of the present invention has at least one bearing overheat indication assembly 150 mounted to end face of at least one cap screw 132.

As best shown by FIGS. 1A and 1B, the indication assembly 150 consists of irreversible temperature indicating label 151, a protective cover 152 that is at least partially transparent and a suitable conventional adhesive 153.

The temperature indicating label 151 includes at least one heat sensitive indicator 154. The indicator 154 is a white chemical coating deposited on a black blotting paper. The black color is therefore hidden beneath the white coating. Once the specific temperature is reach, the white coating melts and is drawn by capillary forces into the black paper, making the background black paper visible and providing a irreversible proof for specified temperature. The temperature indicating label 151 may contain single or multiple heat sensitive indicator 154, each melts at a different temperature.

At least one of three cap screws 132 per bearing have the bearing overheat indication assembly 150 mounted to the head of the cap screw. The temperature indicating label 151 that is packaged within the assembly 150 is further protected by a protective and at least partially transparent cover 152 mounted on top of the label 151 and is further sealed to the head of the cap screw 132 by a suitable adhesive 153 such as silicone, acrylic or epoxy. The protective cover 152 is made of a suitable material including but not limed to glass, polyester, epoxy, acrylic, polyurethane or silicone.

The cover 152 and cured adhesive 153 provide not only long term weather, impact and scratch protection to the temperature indicating label 151, meanwhile, a thermal insulation layer assuring precise thermal indication of internal bearing temperature instead of exterior ambient temperature. The presence of protective cover 152 and cured adhesive 153,

A. provide a sealed and secured environment for the temperature indicating label 151, protecting the label 151 against direct exposure to any harsh working conditions or any unexpected exposure to exterior heat sources;

B. minimize the heat loss from the cap screw 132 therefore making the temperature recording by heat sensitive indicator 154 precise and sensitive to only internal temperature changes within the axle journal 113 and the bearing 130.

In case of bearing failure in railway operation, the excessive amount of heat generated inside bearing 130 or between the axle journal 113 and bearing 130 is transferred rapidly to the head of cap screw 132 where the bearing overheat indication assembly 150 is mounted, through the axle journal 113. The exterior surface of the axle journal 113 and adjacent area where the mounted cap screw 132 is mounted becomes a high temperature zone. Once the temperature of the journal bearing under the running rail car exceeds a specific value, the heat sensitive indicator 154 melts, resulting instant color change of the temperature indicating label 151, leaving a permanent record of high temperatures ever reached inside axle and bearing.

Since the bearing overheat indication assembly 150 follows bearing all the times, the irreversible color changes of single or multiple heat sensitive indicators allow locomotive engineer or other inspectors making positive identification of overheated bearing even after the train stops and the overheated bearing cools down to ambient temperature. Such feature significantly reduces the risk of catastrophic failure and improves the efficiency of physical verification process that is must after triggered wayside hot box alarms. The mounted bearing overheat indication assembly 150, especially the one with multiple heat sensitive indicators 154, also provides a reliable and economical backup for the wayside hot box detector systems in case of wayside detector failures.

As also shown in FIG. 1, another cap screw 162 is mounted to the hub portion of the wheel 120. A wheel overheat indication assembly 170, identical in principle of construction to the bearing overheat indication assembly 150, is mounted to the head of the cap screw 162 for monitoring temperature of the wheel 120. The addition of cap screw 162 and wheel overheat indication assembly 170 provides a physical proof of possible wheel overheat due to excessive wheel tread braking or disc braking and helps to distinguish overheated bearing from overheated wheel upon alarm of wayside detectors.

It should be noted that the cap screw 132 or 162 may have different head profile for best accommodating overheat indication assembly 150 or 170. For example, a protruded round edge or a round recess with straight, tapered or grooved bore may be formed on cap screw head surrounding the temperature indicator assembly 150 for better protection of temperature indicator. It should also be noted that certain locking means such as snap ring may be added to further secure the overheat indication assembly in place.

Referring to FIG. 1C, an alternate arrangement for the embodiment presented in FIG. 1B is provided. In this embodiment, a heat transfer enhancement element in form of a heat pipe 133C is embedded inside the cap screw 132C. Once the cap screw 132C is mounted, the heat pipe 133C provides a heat sink for the axle journal or wheel causing a fluid inside heat pipe 133B to vaporize in the section of heat pipe located deep inside the axle or wheel and to condense at the end of the heat pipe located adjacent to the head of the cap screw 132C where the temperature is lower, therefore transferring the heat rapidly across the heat pipe 133C, as well as the cap screw 132C with small temperature differential.

It should be noted that the heat pipe 133C can be other suitable type of heat transfer enhancement element, for example, a copper or aluminum rod.

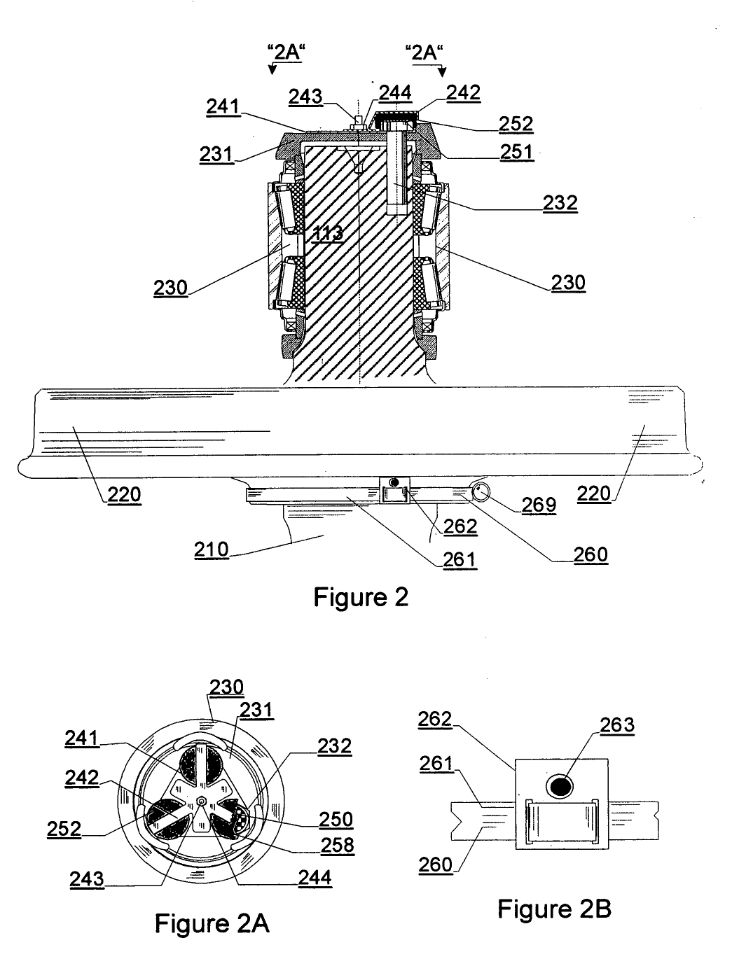

Referring to FIG. 2, FIG. 2A and FIG. 2B, an alternate arrangement for the embodiment presented in FIG. 1 is provided.

As best shown in FIG. 2A, the bearing assembly 230 of the present embodiment also has at least one bearing overheat indication assembly 250 attached to the head of at least one cap screw 232. In this embodiment, an additional protective cover 258 is provided for sealing and protection of attached overheat indication assembly 250. The said cover 258 is further secured by an additional locking plate 242 that is attached to the original locking plate 241 by a suitable means, for example, by bolts 243 and nuts 244 as shown in FIG. 2A. The protective cover 258 is made of one or a combination of several suitable sealing or thermal insulation material including but not limited to rubber, sponge rubber, Silicone foam, fiberglass etc. The additional locking plate 242 is made of any suitable material including but not limited to steel, aluminum, plastic etc.

As best shown in FIG. 2B, another alternative arrangement for wheel overheat indication assembly 260 is provided. The alternative wheel overheat indication assembly 260 includes at least a temperature indicating label 263 mounted and sealed on a mounting plate 262 which is in turn attached to a typical hose clamp 261. The assembly 260 is then positioned to wheel hub and locked in place by tightening the screw 269. The temperature indicating label 263 which is forced to be in close contact with wheel hub by hose clamp 261, provides records of temperature changes in wheel 220.

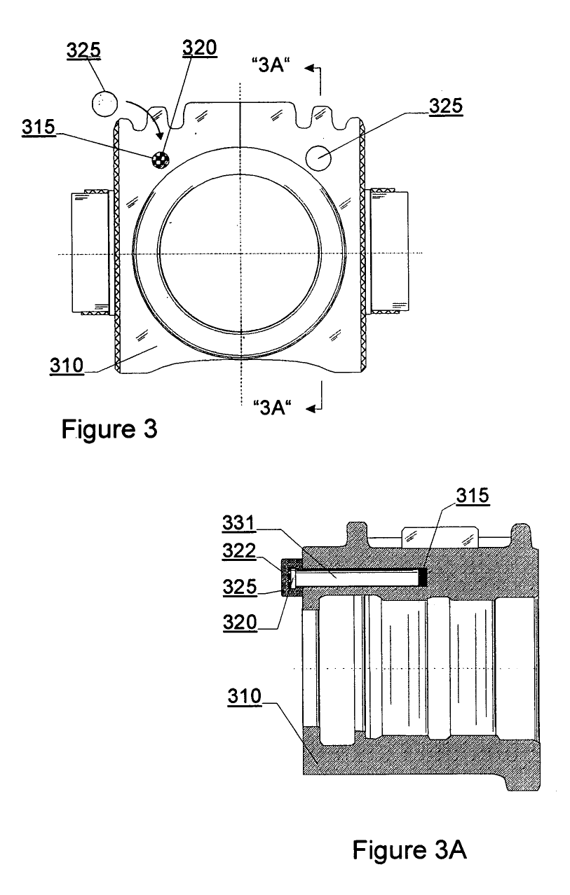

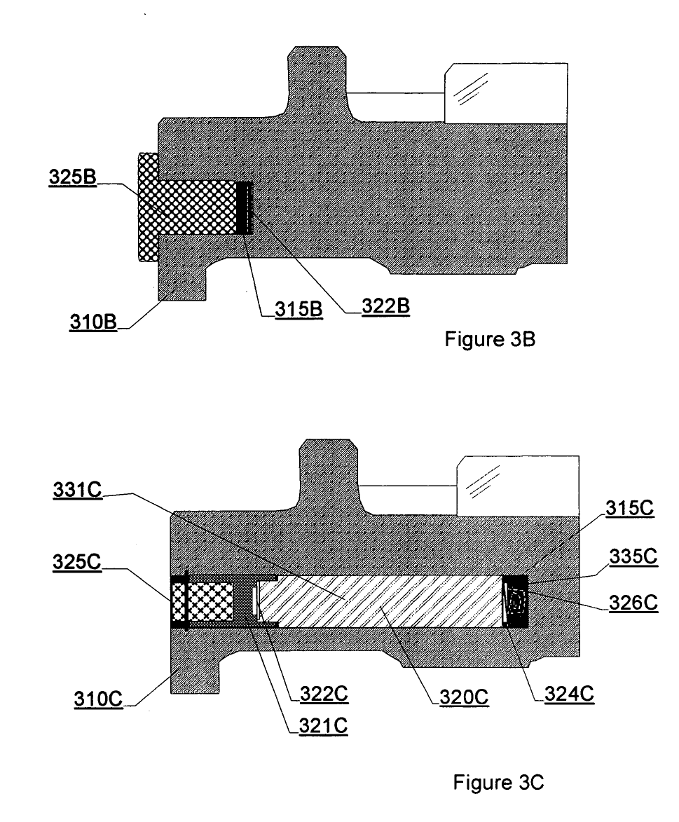

Referring to FIG. 3 and FIG. 3A, a roller bearing adapter 310 is provided for positioning a roller bearing within a pedestal opening of rail car side flame. The roller bearing adapter 310 is slid onto a roller bearing when the rail car is assembled.

In one of upper corners of the bearing adapter 310, substantially near top of bearing cup, a hole 315 is created and a highly thermal conductive cap screw 331 is threadly inserted or slide fit into the hole 315. On the head of the cap screw 331, a screw type bearing overheat indication assembly 320 is pre-mounted for monitoring running condition of the bearing mounted underneath the bearing adapter 310.

The screw type bearing overheat indication assembly 320 consists of a temperature indicating label 322, and a protective cover 325. The label 322 and the protective cover 325 are mounted, by a suitable conventional adhesive, to the head of the highly thermal conductive cap screw 331. The protective cover 325 and the cured adhesive insulate the label 322 from outside harsh working environment or other accidental heat sources. The protective cover 325 also helps to reduce heat loss from the cap screw 331, resulting in more precise internal heat indication.

The highly thermal conductive cap screw 331 is made of any suitable material including but not limited to copper, copper alloys, aluminum, or aluminum alloys. The protective cover 325 is made of one or a combination of several suitable material including but not limited to rubber, sponge rubber, Silicone foam, or fiberglass.

In operation, a certain amount of frictional heat is generated inside bearing and transferred to the end of the highly thermal conductive cap screw 331 through bearing cup and bearing adapter 310. Since roller bearing is vertically loaded from the top, the frictional heat always generated on top part of the bearing. Consequently, the top of the bearing cup, as well as the adjacent bearing adapter 310, including the area around the hole 315, becomes a high temperature zone. Once the temperature of journal bearing under the running rail car exceeds a specific value, the temperature indicating label 322 changes color immediately, leaving a permanent record of bearing overheat ever occurred inside axle and bearing assembly.

Two other alternative embodiments are also shown in FIG. 3B and 3C.

In FIG. 3B, a relatively shallow hole 315B is created in bearing adapter 310B and a temperature indicating label 322B is applied directly to the bottom of the hole 315B. A protective plug 325B is inserted into the hole 315B for protection and thermal insulation of the temperature indicating label 322B.

In FIG. 3C, a hole 315C is created in the bearing adapter 310C and a cartridge-type bearing overheat indication assembly 320C is inserted into the hole 315C.

The cartridge-type bearing overheat indication assembly 320C consists of a highly thermal conductive cartridge-type label carrier 331C, a nut like label cover 321C, two temperature indicating labels 322C/324C, a heat transfer insert 326C and a cone shaped spring 335C.

Two temperature indicating labels 322C and 324C are mounted to the label carrier 331C, with 322C to the front end and 324C to the rear end. The nut like label cover 321C is then threaded onto the front end of the label carrier 331C, locking the edge of the temperature indicating label 322C in place. The heat transfer insert 326C, made of a cluster of copper or aluminum wire, is also incorporated inside the spring 335C. The spring 335C and the heat transfer insert 326C are pre-mounted to the rear end of the label carrier 331C for easy mounting operation. After installation of the bearing overheat indication assembly 320C, a protective plug 325C is then inserted into the center hole of the label cover 321C for protection and thermal insulation of the temperature indicating label 322C and 324C.

The temperature indicating label 322, 322B, 322C and 324C are the same type as the temperature indicating label 151.

It should be noted that the bearing overheat indication assembly 320, 320C may also be attached to other bearing overheat indicator presently used, such as a stench/stink bomb, smoke bomb that may be mounted inside the hole 315 or 315C in bearing adapter 310.

7.Remarks:

1. While all the embodiments of the present invention are depicted and described with a tapered roller bearing assembly and certain type of bearing adapter mounted on a rail car wheel set, it is to be understood that the present invention is also applicable for uses with other types of wheel set assemblies or machinery components, and with other types of bearing and bearing adapter assemblies.

2. While all the embodiments of the present invention are depicted and described with a color changing temperature indicator labels attached to head of cap screw or embedded in bearing adapter, it is to be understood that the present invention is also applicable for use with other types of temperature indicating media that is applied to any other suitable locations, sealed/insulated/protected against outside harsh working environment or other unexpected heat sources, while remains sensitive only to internal temperature changes within the monitored vehicle/machinery component.

While a few of the embodiments of the present invention have been explained, it will be readily apparent to those skilled in the art of the various modifications which can be made to the present invention without departing from the spirit and scope of this application as it is encompassed by the following claims.

What I claim as my invention is:

1. An apparatus for indication of internal overheat generated by a component of a machinery or a vehicle, the apparatus comprising at least:
(a) a component of a machinery or a vehicle that generates internal heat in operation;
(b) a high temperature zone in said component of the vehicle or machinery once said internal heat is generated;
(c) a visible zone on exterior of said vehicle or machinery that is readily accessible for visual inspection;
(d) a highly thermal conductive element embedded in the vehicle or machinery, with one end located adjacent to said high temperature zone and with the other end located in said visible zone;
(e) an overheat indication assembly applied to the end of highly thermal conductive element located in the visible zone, said overheat indication assembly having at least one chemical coating that melts once a specific temperature is reached due to excessive amount of internal heat being generated by said component of the vehicle or machinery.

2. The apparatus for indication of internal overheat, as recited in claim 1, wherein the overheat indication assembly having a temperature indicating label comprising, in addition to the chemical coating,
(a) a paper to which the chemical coating is deposited, said paper being in a different color from the chemical coating and drawing the melted chemical coating into capillary holes in the paper once the specified temperature is reached;
(b) an adhesive backing and a transparent protective film that envelop the paper and the chemical coating, said adhesive backing being attached to the end of the highly thermal conductive element located in the visible zone.

3. The apparatus for indication of internal overheat, as recited in claim 2, wherein the temperature indicating label is encapsulated and sealed to the end of the highly thermal conductive element located in the visible zone by a layer of additional adhesive.

4. The apparatus for indication of internal overheat, as recited in claim 3, wherein the temperature indicating label has an additional transparent cover attached to the top by the additional adhesive, the additional transparent cover being thicker than the protective film.

5. The apparatus for indication of internal overheat, as recited in claim 2, wherein the temperature indicating label having a plurality of different chemical coatings, each coating melts at a different temperature.

6. The apparatus for indication of internal overheat, as recited in claim 1, wherein the highly thermal conductive element is a heat pipe means, providing a heat sink for the component of the machinery or the vehicle causing a fluid inside said heat pipe means to vaporize at the end of the heat pipe located adjacent to the high temperature zone and to condense at the end of the heat pipe located in the visible zone where the temperature is lower, therefore transferring the heat rapidly across the highly thermal conductive element with small temperature differential.

7. The apparatus for indication of internal overheat, as recited in claim 1, wherein the component is a shaft/shaft bearing assembly in a rotary machinery or a vehicle.

8. The apparatus for indication of internal overheat, as recited in claim 7, wherein the component is an axle/roller bearing assembly of a rail car wheel set, comprising at least an axle, a roller bearing mounted to the axle and a bearing adapter mounted onto the roller bearing.

9. The apparatus for indication of internal overheat, as recited in claim 8, wherein
(a) the axle/roller bearing assembly generates excessive amount of internal heat in case of failure;
(b) the high temperature zone lies in the section of the axle underneath the mounted roller bearing;
(c) the highly thermal conductive element is a cap screw mounted to the axle with end of the cap screw located adjacent to the high temperature zone and with head of the cap screw located in the visible zone.
(d) the overheat indication assembly mounted to the head of the cap screw includes a temperature indicating label that changes color at a specific temperature ranged between 200 F and 500 F.
(e) the temperature indicating label is encapsulated and sealed to the head of the cap screw by a layer of adhesive.

10. The apparatus for indication of internal overheat, as recited in claim 8, wherein
(a) the axle/roller bearing assembly generates excessive amount of internal heat in case of failure;
(b) the high temperature zone lies in the section of the bearing adapter in close proximity to the roller bearing;
(c) the highly thermal conductive element is a label carrier mounted inside a hole in the bearing adapter with one end of the label carrier located in the high temperature zone and the other end located in the visible zone;
(d) the overheat indication assembly, mounted to the end of label carrier located in the visible zone, includes a temperature indicating label that changes color at a specific temperature ranged between 200 F and 500 F.

11. The apparatus for indication of internal overheat, as recited in claim 1, wherein the component is a frictional component mounted on a shaft, said frictional component generates heat during frictional engagement.

12. The apparatus for indication of internal overheat, as recited in claim 11, wherein the highly thermal conductive element is a heat pipe means, providing a heat sink for the frictional component in the machinery or the vehicle causing a fluid inside said heat pipe means to vaporize at the end of the heat pipe located in the high temperature zone and to condense at the end of the heat pipe located in the visible zone where the temperature is lower, therefore transferring the heat rapidly across the highly thermal conductive element with small temperature differential.

13. The apparatus for indication of internal overheat, as recited in claim 11, wherein the frictional component is a railway wheel or a railway brake disc used for vehicle braking.

14. The apparatus for indication of internal overheat, as recited in claim 13, wherein
(a) the highly thermal conductive element is a cap screw mounted to the railway wheel or railway brake disc with end of the cap screw located inside the wheel or the brake disc and head of the cap screw located in the visible zone;
(b) the overheat indication assembly mounted to the head of the cap screw includes a temperature indicating label that changes color at a specific temperature;
(c) the temperature indicating label is encapsulated and sealed to the head of the cap screw by a layer of adhesive.

15. The apparatus for indication of internal overheat, as recited in claim 8, wherein said rail car wheel set with an axle/roller bearing assembly comprising at least,
(a) a railway wheel or a railway brake disc used for vehicle braking;
(b) an additional highly thermal conductive element embedded in the railway wheel or railway brake disc, with one end located inside the wheel or brake disc and with the other end located in the visible zone;
(c) an additional overheat indication assembly applied to the end of the additional highly thermal conductive element located in the visible zone, the additional overheat indication assembly having at least one chemical coating that melts once a specific temperature is reached due to the frictional heat generated from the railway wheel or railway brake disc, said additional overheat indication assembly helps to distinguish overheated axle/bearing assembly from overheated railway wheel or railway brake disc.

16. A method for indication of internal overheat generated by a component of a machinery or a vehicle, the method comprising at least:
(a) determining a high temperature zone in the vehicle or machinery once the component is overheated;
(b) selecting a visible zone on exterior of the vehicle or machinery that is readily accessible for visual inspection;
(c) embedding a highly thermal conductive element in the vehicle or machinery, with one end located in the high temperature zone and with the other end located in the visible zone;
(d) applying an overheat indication assembly to the end of highly thermal conductive element located in the visible zone, the overheat indication assembly having at least one chemical coating that melts once a specific temperature is reached due to excessive amount of internal heat being generated by said component of the vehicle or machinery.

17. The method for indication of internal overheat, as recited in claim 16, wherein the overheat indication assembly having a temperature indicating label comprising, in addition to the chemical coating,
(a) a paper to which the chemical coating is deposited, said paper being in a different color from the chemical coating and drawing the melted chemical coating into capillary holes in the paper once the specified temperature is reached;
(b) an adhesive backing and a transparent protective film that envelop the paper and the chemical coating, said adhesive backing being attached to the end of the highly thermal conductive element located in the visible zone.

18. The method for indication of internal overheat, as recited in claim 17, wherein the temperature indicating label is encapsulated and sealed to the end of the highly thermal conductive element located in the visible zone by a layer of additional adhesive.

19. The method for indication of internal overheat, as recited in claim 18, wherein the temperature indicating label has an additional transparent cover attached to the top by the additional adhesive, the additional transparent cover being thicker than the protective film.

20. The method for indication of internal overheat, as recited in claim 17, wherein the temperature indicating label having a plurality of different chemical coatings, each coating melts at a different temperature.

21. The method for indication of internal overheat, as recited in claim 16, wherein the highly thermal conductive element is a heat pipe means, providing a heat sink for the component of the machinery or the vehicle causing a fluid inside said heat pipe means to vaporize at the end of the heat pipe located adjacent to the high temperature zone and to condense at the end of the heat pipe located in the visible zone where the temperature is lower, therefore transferring the heat rapidly across the highly thermal conductive element with small temperature differential.

22. The method for indication of internal overheat, as recited in claim 16, wherein the component is a shaft/shaft bearing assembly in a rotary machinery or a vehicle.

23. The method for indication of internal overheat, as recited in claim 22, wherein the component is an axle/roller bearing assembly of a rail car wheel set, comprising at least an axle, a roller bearing mounted to the axle and a bearing adapter mounted onto the roller bearing.

24. The method for indication of internal overheat, as recited in claim 23, wherein
(a) the axle/roller bearing assembly generates excessive amount of internal heat in case of failure;
(b) the high temperature zone lies in the section of the axle underneath the mounted roller bearing;
(c) the highly thermal conductive element is a cap screw mounted to the axle with end of the cap screw located adjacent to the high temperature zone and with head of the cap screw located in the visible zone;
(d) the overheat indication assembly mounted to the head of the cap screw includes a temperature indicating label that changes color at a specific temperature ranged between 200 F and 500 F;
(e) the temperature indicating label is encapsulated and sealed to the head of the cap screw by a layer of adhesive.

25. The method for indication of internal overheat, as recited in claim 23, wherein
(a) the axle/roller bearing assembly generates excessive amount of internal heat in case of failure;
(b) the high temperature zone lies in the section of the bearing adapter in close proximity to the roller bearing;
(c) the highly thermal conductive element is a label carrier mounted inside a hole in the bearing adapter with one end of the label carrier located in the high temperature zone and the other end located in the visible zone;
(d) the overheat indication assembly, mounted to the end of label carrier located in the visible zone, includes a temperature indicating label that changes color at a specific temperature ranged between 200 F and 500 F.

26. The method for indication of internal overheat, as recited in claim 16, wherein the component is a frictional component mounted on a shaft, said frictional component generates heat during frictional engagement.

27. The method for indication of internal overheat, as recited in claim 26, wherein the highly thermal conductive element is a heat pipe means, providing a heat sink for the frictional component in the machinery or the vehicle causing a fluid inside said heat pipe means to vaporize at the end of the heat pipe located in the high temperature zone and to condense at the end of the heat pipe located in the visible zone where the temperature is lower, therefore transferring the heat rapidly across the highly thermal conductive element with small temperature differential.

28. The method for indication of internal overheat, as recited in claim 26, wherein the frictional component is a railway wheel or a railway brake disc used for vehicle braking.

29. The method for indication of internal overheat, as recited in claim 28, wherein
(a) the highly thermal conductive element is a cap screw mounted to the railway wheel or railway brake disc with end of the cap screw located inside the wheel or the brake disc and head of the cap screw located in the visible zone;
(b) the overheat indication assembly mounted to the head of the cap screw includes a temperature indicating label that changes color at a specific temperature;
(c) the temperature indicating label is encapsulated and sealed to the head of the cap screw by a layer of adhesive.

30. The method for indication of internal heat, as recited in claim 23, wherein said rail car wheel set with an axle/roller bearing assembly comprising at least,
(a) a railway wheel or a railway brake disc used for vehicle braking;
(b) an additional highly thermal conductive element embedded in the railway wheel or railway brake disc, with one end located inside the wheel or brake disc and with the other end located in the visible zone;
(c) an additional overheat indication assembly applied to the end of the additional highly thermal conductive element located in the visible zone, the additional overheat indication assembly having at least one chemical coating that melts once a specific temperature is reached due to the frictional heat generated from the railway wheel or railway brake disc, said additional overheat indication assembly helps to distinguish overheated axle/bearing assembly from overheated railway wheel or railway brake disc.

31. The method for indication of internal overheat, as recited in claim 25, wherein the label carrier has a spring pre-mounted to the end before installation of the label carrier inside the bearing adapter.
